(19) United States
(12) Patent Application Publication
(10) Pub. No.: US 2008/0092197 A1
(43) Pub. Date: Apr. 17, 2008

(54) METHOD OF UPGRADING SOFTWARE BY USING COMMON MODULE SHARED BY MULTIPLE MODELS, AND DIGITAL BROADCAST RECEIVER THEREFOR

(75) Inventor: Kwang-hyun KOH, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/733,038

(22) Filed: Apr. 9, 2007

(30) Foreign Application Priority Data
Oct. 13, 2006 (KR) 10-2006-0100008

(51) Int. Cl. H04N 7/16; G06F 15/177; H04N 7/173; G06F 9/00

(52) U.S. Cl. 725/132; 725/140; 725/152; 713/2

(57) ABSTRACT

Provided are a method of upgrading software by using a common module shared by a plurality of models, and a digital broadcast receiver therefor. The method includes receiving a digital broadcast signal which contains a common module shared by a plurality of models of the digital broadcast receiver, separately from a unique module of the digital broadcast receiver; determining whether to upgrade each module of the digital broadcast receiver, when it is determined that software upgrading is needed, according to predetermined update information; and collecting DownloadDataBlocks (DDBs) for a module, which is to be upgraded, from the received digital broadcast signal, in order to form a module. The common module is transmitted in the form of a group different than a group to which the common module belongs or in the form of another group, thereby saving bandwidth for software upgrading.

### CROSS-REFERENCE TO RELATED PATENT APPLICATIONS

This application claims priority from Korean Patent Application No. 10-2006-0100008, filed on Oct. 13, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to upgrading software by using a common module shared by a plurality of models, and a digital broadcast receiver therefor.

2. Description of the Related Art

As terrestrial digital broadcasting becomes widespread, there is an increasing need to upgrade the complicated software for a digital broadcast receiver. In order to upgrade terrestrial digital broadcasting, a standard, such as the ATSC A97 standard, for upgrading software for a digital broadcast receiver by using a data carousel, is used.

However, according to the ATSC A97 standard, a Download Information Indication (DII) corresponds to one model of a digital broadcast receiver, and the number of models, which have upgrading software capable of being supported by a data carousel, is limited.

Also, when there is a file shared by models of the same manufacturing company, each model uses a DII, and thus, data must be redundantly transmitted, thereby causing inefficient use of a bandwidth and increasing costs.

### SUMMARY OF THE INVENTION

The present invention provides a method of upgrading software by allowing a plurality of models to share the same file, thereby reducing a bandwidth for software upgrading, and a digital broadcast receiver therefor.

According to an aspect of the present invention, there is provided a method of upgrading software in a digital broadcast receiver by using a common module shared by a plurality of models, the method comprising (a) receiving a digital broadcast signal which contains a common module shared by a plurality of models of the digital broadcast receiver, separately from a unique module of the digital broadcast receiver; (b) determining whether to upgrade each module of the digital broadcast receiver, when it is determined that software upgrading is needed, according to predetermined update information; and (c) collecting DownloadDataBlocks (DDBs) for a module, which is to be upgraded, from the received digital broadcast signal, in order to form a module.

The common module may be transmitted in the form of a group that is different than a group to which the unique module belongs. (b) may comprise (b1) when a group to which the common module belongs is present in an iterative software loop of DownloadServerInitiate (DSI) included in the digital broadcast signal, receiving corresponding DIIs; and (b2) searching a common module list included in the DII for modules identical to the modules of the digital broadcast receiver, and determining whether each module of the digital broadcast receiver needs to be upgraded by comparing the versions of the searched modules with the versions of the modules of the digital broadcast receiver.

The common module list may comprise information regarding modules shared by two or more models.

The predetermined update information may comprise at least one of a model number, a manufacturing company, and a module version of the digital broadcast receiver.

The common module may be transmitted in the form of the group to which the unique module belongs. (b) may comprise (b1) when a group corresponding to the model number of the digital broadcast receiver is present in the iterative software loop of the DSI included in the digital broadcast signal, receiving a corresponding DII; (b2) searching modules, which are defined in the received DII, for the common module by using predetermined common module information; and (b3) determining whether to upgrade each of the modules of the digital broadcast receiver by comparing the version of the common module with the versions of the modules of the digital broadcast receiver.

The predetermined common module information may comprise one of a predetermined file name, an additional update information file, and information described in PrivateModuleByte which is a message included in a separately provided ModuleInfoDescriptor.

According to another aspect of the present invention, there is provided a digital broadcast receiver for upgrading software by using a common module shared by a plurality of models, the digital broadcast receiver comprising a virtual channel table parsing unit analyzing whether a digital broadcast signal is related to software upgrading, where the digital broadcast signal contains a common module shared by a plurality of models of the digital broadcast receiver, separately from a unique module of the digital broadcast receiver; a software upgrade unit determining whether to upgrade each module of the digital broadcast receiver when it is determined that software upgrading is needed, according to predetermined upgrade information, and collecting corresponding DDBs from the received digital broadcast signal in order to form a module; and a software storage unit storing the formed module.

The common module may be transmitted in the form of a group that is different than a group to which the unique module belongs, or in the form of a group to which the unique module belongs.

If the common module is transmitted in the form of the group that is different than the group to which the unique module belongs, the software upgrade unit may search a module list included in corresponding DII for modules corresponding to the digital broadcast receiver and determine whether to upgrade each module of the digital broadcast receiver by comparing the versions of the searched modules with the versions of the modules of the digital broadcast receiver, when a group to which the common module belongs is present in an iterative software loop of DSI included in the digital broadcast signal.

If the common module is transmitted in the form of the group to which the unique module belongs, the software upgrade unit may search modules defined in a corresponding DII for the common module by using predetermined common module information and determine whether to upgrade each module of the digital broadcast receiver by comparing the version of the searched common module with the versions of the modules of the digital broadcast receiver, when a group corresponding to the model number of the digital broadcast receiver is present in an iterative software loop of DSI included in the digital broadcast signal.

The module list may comprise information regarding modules shared by two or more models. The predetermined update information may comprise at least one of a model number, a manufacturing company, and a module version of the digital broadcast receiver.

The predetermined common module information may comprise one of a predetermined file name, an additional update information file, or information described in PrivateModuleByte which is a message included in a separately provided module ModuleInfoDescriptor.

According to another aspect of the present invention, there is provided a computer readable medium having recorded thereon a computer program for executing the method.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating the structure of control information transmitted in a 2-layer during transmission of a module via a data carousel;

FIG. 2 is a block diagram of a data broadcast receiver for software upgrading;

FIG. 3 illustrates the syntax of a group information indication (GII);

FIG. 4 illustrates the syntax of a digital storage medium command and control (DSM-CC) compatibility descriptor;

FIG. 5 illustrates the syntax of a DII;

FIG. 6 illustrates the syntax of ModuleInfoDescriptor;

FIG. 7 is a flowchart illustrating a method of upgrading software according to an exemplary embodiment of the present invention; and

FIG. 8 is a flowchart illustrating a method of upgrading software according to another exemplary embodiment of the present invention.

### DETAILED DESCRIPTION OF THE EXEMPLARY EMBODIMENTS OF THE INVENTION

Hereinafter, a method of upgrading software by using a common module shared by a plurality of models and a digital broadcast receiver therefor according to exemplary embodiments of the present invention will be described in detail with reference to the accompanying drawings. Like reference numerals denote like elements throughout the specification. Also, particular matters, such as constitutional elements of a circuit, are described in this disclosure but they are provided only to help understand the present invention, and it would be apparent to those of ordinary skill in the art that the present invention is not limited thereto. Additional aspects of the invention will be set forth in part in the description which follows and, in part, will be obvious from the description, or may be learned by practice of the invention. In this specification, if it is determined that detailed descriptions related to functions or constructions well-known in the art make the concept of the present invention obscure, the detailed descriptions will be omitted.

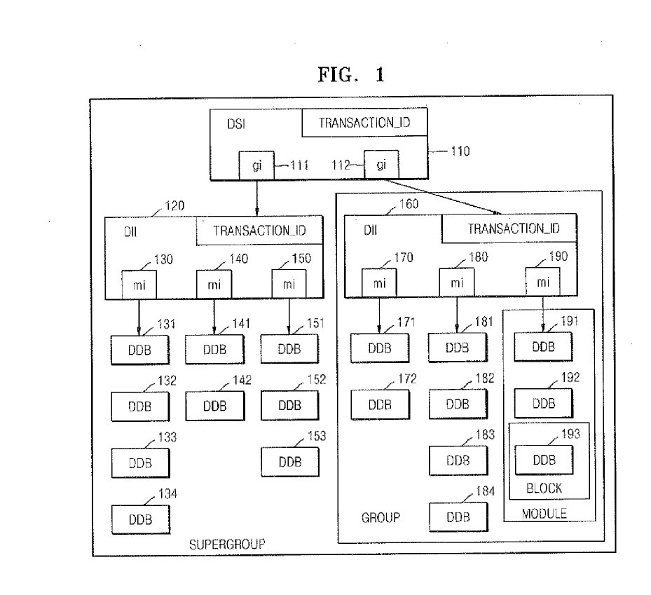

FIG. 1 is a block diagram illustrating the structure of control information transmitted in a 2-layer during transmission of a module via a data carousel. Referring to FIG. 1, DSI 110 contains two pieces of group information, i.e., first group information GroupID (gi) 111 and second group information gi 112. The first group information gi 111 indicates a first DII 120, and the second group information gi 112 indicates second DII 160. The first DII 120 contains first module information ModuleID (mi) 130, second module information mi 140, and third module information mi 150. The module information mi 130 contains information regarding DDBs 131 through 134, the module information mi 140 contains information regarding DDBs 141 and 142, and the module information mi 150 contains information regarding DDBs 151 through 153. Similarly, a second DII 160 contains module information mi 170 through 190, each containing information regarding DDBs. That is, DDBs called by a piece of module information mi form a module, modules indicated by a DII form a group, and groups indicated by a DSI form a super group.

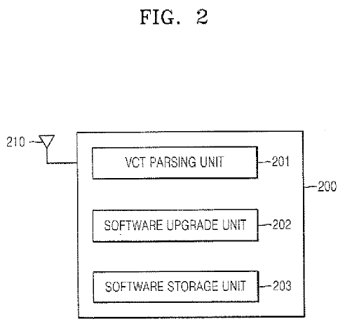

FIG. 2 is a block diagram of a digital broadcast receiver 100 for software upgrading. The digital broadcast receiver 100 includes a Virtual Channel Table (VCT) parsing unit 201, a software upgrade unit 202, and a software storage unit 203. In this disclosure, constitutional elements related to embodiments of the present invention will be described in greater detail.

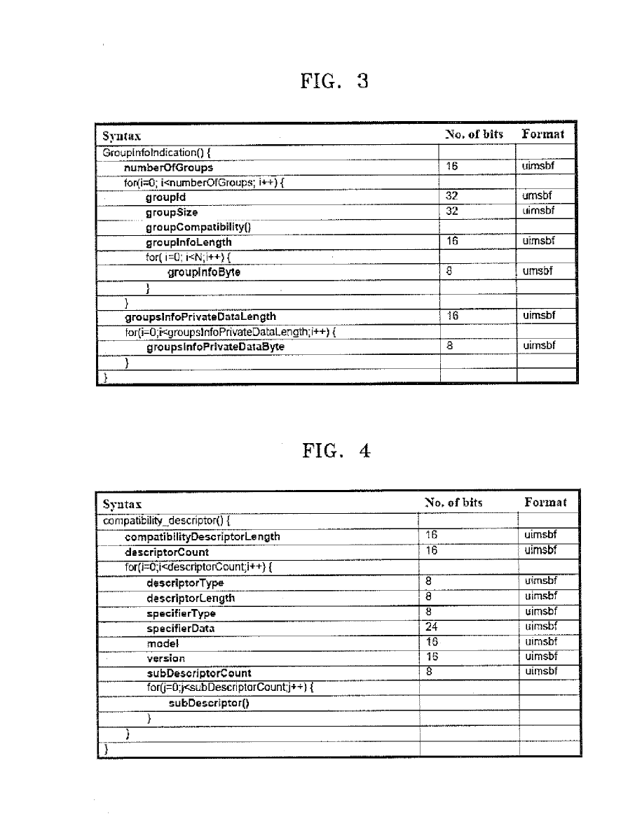

FIGS. 3 through 6 respectively illustrate the syntaxes of GII, DSM-CC compatibility descriptor, a DII message, and a ModuleInfoDescriptor, which will be described with reference to FIG. 2.

Referring to FIG. 2, the VCT parsing unit 201 detects a VCT from a digital broadcast signal that is input from the outside. The digital broadcast signal contains a common module shared by a plurality of models of the digital broadcast receiver 200, separately from a unique module of the digital broadcast receiver 200. According to an embodiment of the present invention, the common module may be transmitted in the form of a group to which the unique module belongs or in the form of another group.

If the VCT is detected, it is determined whether a service type is OX05 based on the VCT. The service type OX05 indicates that a transmitted signal is related to software upgrading.

When it is determined that software upgrading is needed based on predetermined update information, the software upgrade unit 202 determines whether software upgrading is to be performed in units of modules, and collects corresponding DDBs so as to construct a module.

The software storage unit 203 stores the module collected by the software upgrade unit 202.

The functions of the software upgrade unit 202 will now be described in greater detail. If the service type OX05 is detected from the received signal, the software upgrade unit 202 detects Packet Identification (PID) of DSI from a program map table (PMT) based on the service type OX05. Then, a DSI table is filtered using the detected PID.

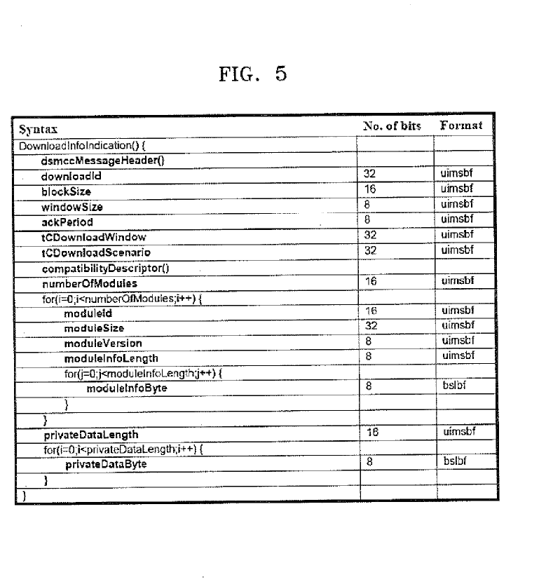

Also, compatibility descriptors of all GIIs included in the DSI table are checked in order to determine whether corresponding groups match the manufacturing company, a model, or a version of the digital broadcast receiver 200. Examples of a GII and the compatibility descriptor are illustrated in FIGS. 3 and 4.

In the compatibility descriptor illustrated in FIG. 4, specifierData, model, and version denote the manufacturing company, model, and version of the digital broadcast receiver 100, respectively.

When there is a group corresponding to the digital broadcast receiver 200, the software upgrade unit 202 receives a corresponding DII, and receives a required module based on information obtained from the DII.

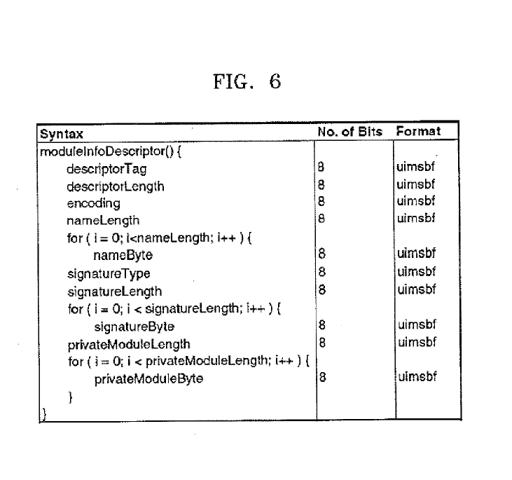

The DII message is illustrated in FIG. 5.

In this disclosure, two exemplary embodiments of the present invention are introduced. They are categorized into a case where data shared by a plurality of models is present and transmitted in the form of different groups, and a case where a plurality of models form a single group.

The two exemplary embodiments of the present invention will now be described.

(1) When data shared by a plurality of models is independently present and transmitted in the form of different groups:

In this case, an independent common model containing the shared data is present, and thus, the software upgrade unit 202 searches for a group having the common model number. If a group having the shared data is detected, a corresponding DII is received, and a common module list is detected from the DII.

Next, it is determined whether the common module list has a module identical to the module of the digital broadcast receiver 200, and when the identical module is present, the version of the identical module is checked in order to determine whether to upgrade the module of the digital broadcast receiver 200.

If there is a module to be upgraded, DDBs of a data carousel are received so as to be used to form a module. After all the common modules are collected, they are combined with specific modules of the digital broadcast receiver 200.

(2) When a plurality of models form a single group:

When a plurality of models form a group, the group of models is given a group number. Thus, when receiving DSI, the software upgrade unit 202 determines whether a group having the same group number as a group to which the digital broadcast receiver 200 belongs is present in an iterative software loop included in the DSI.

If a group having the same group number is present, the DII of this group is received. Modules defined in the received DII may comprise a common module and unique modules of a plurality of receivers. Whether each of the defined modules is a common module or a unique module may be determined by a predetermined file name, an additional update information file, or information contained in privateModuleByte in a ModuleInfoDescriptor. The ModuleInfoDescriptor containing privateModuleByte is illustrated in FIG. 6,

The versions of the common modules and unique modules defined in the received DII are compared with those of modules used in the digital broadcast receiver 200, modules of later versions are received, and modules of the digital broadcast receiver 200 are upgraded with the received modules.

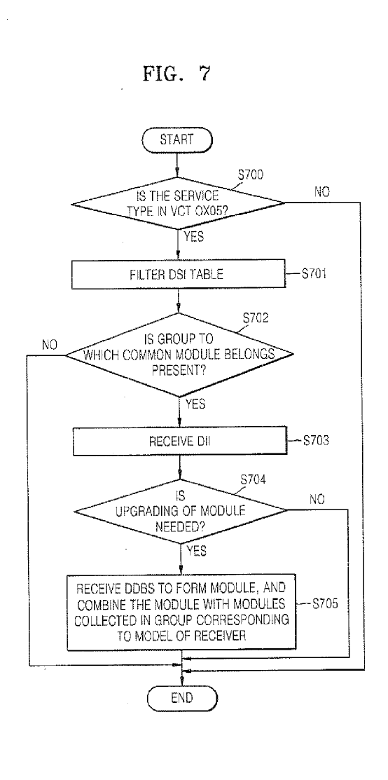

FIG. 7 is a flowchart illustrating a method of upgrading software according to an embodiment of the present invention. In particular, FIG. 7 illustrates a method of upgrading software when a common module is transmitted in the form of a group that is different than a group to which a unique module belongs.

Referring to FIG. 7, in operation S700, the VCT parsing unit 201 of FIG. 2 determines whether the service type in a VCT included in a digital broadcast signal received from the outside is 0x05.

In operation S701, if the service type is 0x05, the software upgrade unit 202 searches a PMT for PID of DSIs, and filters a DSI table by using the PID.

In operation S702, compatibility descriptors of all GIIs included in the DSI table are checked in order to determine whether a corresponding group matches the manufacturing company, model, or version of the digital broadcast receiver 200.

In operation S703, a corresponding DII is received.

In operation S704, a common module list is detected from the received DII. It is determined whether the common module list has a module identical to modules of the digital broadcast receiver 200, and when the identical module is present, the version of the identical module is checked in order to determine whether to upgrade the modules of the digital broadcast receiver 200.

In operation S705, if there is a module to be upgraded, DDBs of a data carousel are received to form a module. When all the common modules are collected, the collected modules are combined with specific modules of a group corresponding to the model of the digital broadcast receiver 200.

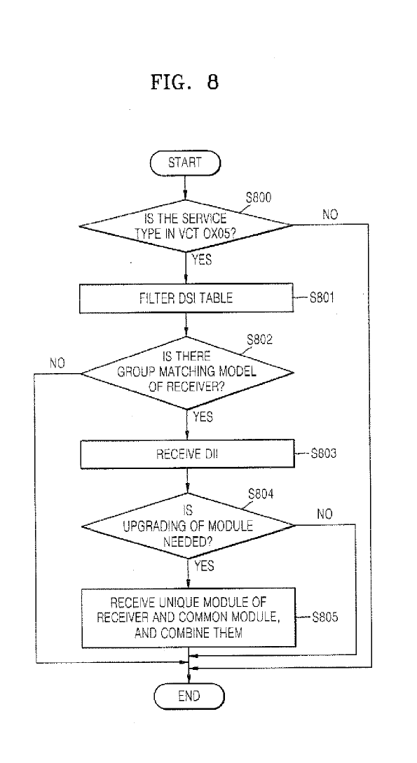

FIG. 8 is a flowchart illustrating a method of upgrading software according to an embodiment of the present invention. In particular, FIG. 8 illustrates a method of upgrading software when a plurality of models form a single group. Referring to FIG. 8, in operation S800, the VCT parsing unit 201 determines whether the service type in a VCT included in a digital broadcast signal received from the outside is 0x05.

In operation S801, when the service type is 0x05, the software upgrade unit 202 searches a PMT for PID of DSIs, and a DSI table is filtered using the PID.

In operation S802, compatibility descriptors of all GIs included in the DSI table are checked in order to determine whether a corresponding group matches the manufacturing company, model, or version of the digital broadcast receiver 200. Unlike in the method illustrated in FIG. 7, when a plurality of models form a single group, the group is given a group number. Thus, when a DSI is received, it is determined whether a group having the same group as a group to which the digital broadcast receiver 200 belongs is present in an iterative software loop included in the DSI.

In operation S803, when a group having the same model number is present, a corresponding DII is received. Modules defined in the received DII may be a common module and unique modules of different receivers. Thus, as described above, whether each of the defined modules is a common module or a unique module is determined by a predetermined file name, an additional update information file, or information contained in privateModuleByte included in the ModuleInfoDescriptor.

In operations S804 and S805, the versions of the common and unique modules defined in the received DII are compared with those of modules used in the digital broadcast receiver 200, modules of later versions are received, and the modules of the digital broadcast receiver 200 are upgraded with the received modules.

As described above, when similar software installed in digital broadcast receivers are upgraded in a broadcast network, it is possible to save broadcast bandwidth and reduce costs of software upgrading by sharing software if possible.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of upgrading software in a digital broadcast receiver by using a common module shared by a plurality of digital broadcast receivers, the method comprising:
receiving a digital broadcast signal which contains a common module shared by the plurality of the digital broadcast receivers, separately from a unique module of the digital broadcast receiver;
determining whether to upgrade each of modules of the digital broadcast receiver, if it is determined that software upgrading is needed, according to predetermined update information; and
collecting DownloadDataBlocks (DDBs) for a module to be upgraded from the received digital broadcast signal to form an upgraded module.

2. The method of claim 1, wherein the common module is transmitted in a form of a first group that is different than a second group to which the unique module belongs.

3. The method of claim 2, wherein the determining whether to upgrade each module of the digital broadcast receiver comprises:
if the first group to which the common module belongs is present in an iterative software loop of DownloadServerInitiate (DSI) included in the digital broadcast signal, receiving corresponding Download Information Indications (DIIs); and
searching a common module list included in the DII for modules identical to the modules of the digital broadcast receiver, and determining whether each of the modules of the digital broadcast receiver needs to be upgraded by comparing versions of the searched modules with corresponding versions of the modules of the digital broadcast receiver.

4. The method of claim 3, wherein the common module list comprises information regarding modules shared by two or more of the plurality of digital broadcast receivers.

5. The method of claim 1, wherein the predetermined update information comprises at least one of a model number of the digital broadcast receiver, a manufacturing company of the digital broadcast receiver, and a module version of the digital broadcast receiver.

6. The method of claim 1, wherein the common module is transmitted in a form of a group to which the unique module belongs.

7. The method of claim 6, wherein determining whether to upgrade each of the modules of the digital broadcast receiver comprises:
if a group corresponding to a model number of the digital broadcast receiver is present in an iterative software loop of the DownloadServerInitiate (DSI) included in the digital broadcast signal, receiving a corresponding Download Information Indications (DII);
searching modules which are defined in the received DII, for the common module by using predetermined common module information; and
determining whether to upgrade each of the modules of the digital broadcast receiver by comparing a version of the common module with versions of the modules of the digital broadcast receiver.

8. The method of claim 7, wherein the predetermined common module information comprises one of a predetermined file name, an additional update information file, and information described in PrivateModuleByte which is a message included in a separately provided ModuleInfoDescriptor.

9. A digital broadcast receiver for upgrading software by using a common module shared by a plurality of digital broadcast receivers, the digital broadcast receiver comprising:
a virtual channel table parsing unit which analyzes whether a digital broadcast signal is related to software upgrading, the digital broadcast signal containing a common module shared by the plurality of digital broadcast receivers, separately from a unique module of the digital broadcast receiver;
a software upgrade unit which determines whether to upgrade each of modules of the digital broadcast receiver if it is determined that software upgrading is needed, according to predetermined upgrade information, and collects corresponding DownloadDataBlocks (DDBs) from the received digital broadcast signal in order to form an upgraded module; and
a software storage unit storing the upgraded module.

10. The digital broadcast receiver of claim 9, wherein the common module is transmitted in a form of a first group that is different than a second group to which the unique module belongs.

11. The digital broadcast receiver of claim 9, wherein the common module is transmitted in a form of a group to which the unique module belongs.

12. The digital broadcast receiver of claim 10, wherein, if the common module is transmitted in the form of the first group that is different than the second group to which the unique module belongs, the software upgrade unit searches a module list included in corresponding Download Information Indications (DII) for modules corresponding to the digital broadcast receiver and determines whether to upgrade each of modules of the digital broadcast receiver by comparing versions of the searched modules with corresponding versions of the modules of the digital broadcast receiver, if the first group to which the common module belongs is present in an iterative software loop of DownloadServerInitiate (DSI) included in the digital broadcast signal.

13. The digital broadcast receiver of claim 11, wherein, if the common module is transmitted in the form of the group to which the unique module belongs, the software upgrade unit searches modules defined in a corresponding Download Information Indications (DII) for the common module by using predetermined common module information and determines whether to upgrade each of modules of the digital broadcast receiver by comparing version of the searched common module with versions of the modules of the digital broadcast receiver, if a group corresponding to the model number of the digital broadcast receiver is present in an iterative software loop of DownloadServerInitiate (DSI) included in the digital broadcast signal.

14. The digital broadcast receiver of claim 12, wherein the module list comprises information regarding modules shared by two or more digital broadcast receivers.

15. The digital broadcast receiver of claim 9, wherein the predetermined update information comprises at least one of a model number of the digital broadcast receiver, a manufacturing company of the digital broadcast receiver, and a module version of the digital broadcast receiver.

16. The digital broadcast receiver of claim 13, wherein the predetermined common module information comprises one of a predetermined file name, an additional update information file, or information described in PrivateModuleByte which is a message included in a separately provided module ModuleInfoDescriptor.

17. A computer readable medium having recorded thereon a computer program for executing the method of any one of claims 1 through 8.
